(19) United States
(12) Patent Application Publication
(10) Pub. No.: US 2004/0232601 A1
(43) Pub. Date: Nov. 25, 2004

(54) Continuous twin sheet thermoforming process and apparatus

(76) Inventors: James Kundinger, Auburn, MI (US); Jason Winans, Midland, MI (US); William F. Kent, Beaverton, MI (US)

Correspondence Address: John R. Benefiel, Suite 100 B, 280 Daines Street, Birmingham, MI, 48009, US

(21) Appl. No.: 10/821,113

(22) Filed: Apr. 8, 2004

Related U.S. Application Data
(60) Provisional application No. 60/461,475, filed on Apr. 8, 2003.

(51) Int. Cl. B29C 51/02

(52) U.S. Cl. 264/544; 264/148; 425/308

(57) ABSTRACT

A twin sheet thermoformer apparatus and method in which an extruder continuously produces a sheet of hot plastic which is cut into cut sheets while the sheet is exiting the extruder, which are loaded in pairs into a series of transfer cars which are moved successively to an oven and then to a forming station. Sets of mold assemblies include pairs of molds with cavities which are faced upwardly to receive sheets lowered thereon and molded in the cavities and are then pivoted to face each other and moved together to fuse the molded sheets together to form a hollow part.

### CROSS REFERENCE TO RELATED APPLICATIONS

This application claims the benefit of U.S. provisional Serial No. 60/461,475, filed Apr. 8, 2003.

### BACKGROUND OF THE INVENTION

This invention concerns thermoforming, a well known process for molding articles from preheated plastic sheet material, using a vacuum and/or air pressure to assist in drawing the sheets into conformity with mold surfaces.

In an extension of this process, twin sheet forming has heretofore been developed in which two sheets are thermoformed separately, and the two formed pieces are pressed together while still in their respective molds to fuse the same together and produce a complete part.

This process is used in forming large hollow parts such as fuel tanks.

Conventionally, the sheets are precut and stored prior to being thermoformed, and are at room temperature (or below if stored outside in cold weather). It thus is necessary to heat the sheets in the thermoforming apparatus to the temperature necessary for the molding to be carried out.

Particularly for heavier multilayer sheets as are used to mold fuel tanks, preheating is required to slowly bring the sheets up to temperature for the reasons described in US 2002/0017745 A1.

This complicates the apparatus and also slows the process considerably as the preheating takes substantial time.

A transfer system, either linear or rotary, is typically used in twin sheet thermoformers to move a car holding two of the sheets from a loading station through a preheating, oven and to a forming station. See U.S. Pat. No. 6,454,557 B1, issued on Sep. 24, 2002 and U.S. Pat. No. 3,925,140, issued on Dec. 9, 1975 and U.S. Pat. No. 6,382,953 B1, issued on May 7, 2002, for examples.

This extended preheating step has precluded a continuous thermoforming process for this type of thermoforming operation.

The twin sheet forming process also must allow for insertion of components into the fuel tank during processing prior to fusing of the two molded pieces so as to seal the components in the tank and avoid any openings in the fuel tank wall through which fittings, etc., are extended.

It is one object of the present invention to provide a thermoforming process in which preheating of the sheet material is not required.

It is a further object to provide a continuous twin sheet thermoforming process which does not require storage and handling of precut stored sheets.

### SUMMARY OF THE INVENTION

The above recited objects and other objects which will become apparent upon a reading of the following specification and claims are achieved by combining an extruder with a thermoforming apparatus so that a hot extruded plastic sheet feeds directly into the thermoformer apparatus such that the continuously extruded plastic sheet is hot when received.

The continuous hot sheet is sheared into discrete sheet lengths which are alternately loaded into two take away shuttles, conveyor sections which are alternately positioned ahead of the extruder die and a “flying” shear which cuts the extruded sheet into discrete lengths.

The two section shuttles may be cooled to lower the temperatures of the hot sheets, depending on the operating requirements and conditions.

Each of the conveyor section shuttles shifts between a position aligned with the extruder die and shear where it receives a discrete length hot sheet of plastic and a position aligned with a sheet support comprised of a fixed conveyor table aligned beneath a respective one of two clamping frames mounted on one of three sheet transfer cars, where it discharges its sheet onto the fixed conveyor table.

When both fixed conveyor sections are loaded, the above located sheet transfer car is lowered by a lift/lower mechanism to the fixed conveyor table and grippers on each clamping frame clamp to a respective sheet on a respective fixed conveyor table, and the transfer car is then raised to be able to be advanced linearly along a track into an oven, where both sheets are heated to the proper final forming temperatures.

A retractable sheet squaring mechanism can be included in the loading area lift/lower mechanism to insure proper orientation of each sheet prior to being clamped in the clamping frames. Alternatively, sheet guides can be provided on the fixed conveyor tables.

At the same time, a second transfer car previously in the oven is simultaneously linearly advanced into a forming station in a position located above a first set of two side-by-side forming mold assemblies to locate each of the two sheets in the respective clamping frames over a respective one of two molds in the first mold assembly set.

A forming station lift/lower mechanism lowers the second transfer car in the forming station to bring the sheets carried in the associated clamping frames down onto the upturned molds. A mold plug set on the lift mechanism may also be carried down with the second transfer car, which mold plugs can be extended to assist the thermoforming of the sheets with an applied mold vacuum, to mold the sheets into conformity with the mold cavities.

The clamping frame grippers are released from the sheets at this time so that the lift/lower mechanism can raise the second transfer car to an elevated position above the level of the top of the oven, so that a second linear transfer system can transfer the same back to the load station at a point above the fixed conveyor tables.

A third transfer car has in the meantime previously been lowered over the conveyor tables and another two sheets have been clamped into its clamping frames.

With the transfer car in the form station elevated out of the way, a robot can emplace inserts as necessary into the cavities in the formed sheets.

Each mold in the first mold assembly set is pivotally mounted and able to be tilted as with hydraulic actuators to be rotated from an upward facing position of its cavities to a rotated down position to bring their respective mold cavities into an opposing or facing relative position.

The two mold assemblies are also mounted for relative linear motion to bring exposed portions of the two formed sheets into abutment, as by moving one mold against the other which is held stationary. The molds are locked and hydraulically forced together to fuse the formed sheets together into a complete part.

The first mold set assembly is transferred out of the forming station to an adjacent cooling unloaded area, while a second mold assembly set is simultaneously transferred into the forming station with its mold cavities in a tilted up position by a linearly movable platform which mounts both sets of mold assemblies.

After sufficient cooling of the first set of mold assemblies, the molds are unlocked and separated. Upon pivoting back to a cavity up position the completed part retained in one of the molds is removed, as by a robot.

The first mold assembly set is then ready to be shifted into position for another cycle when the second mold assembly is ready to be shifted into a cooling unload area adjacent thereto.

### DESCRIPTION OF THE DRAWINGS

FIG. 1 is a simplified diagram of the major components of the apparatus according to the invention.

FIG. 2 is a simplified diagram of the movement of three transfer cars through the stations included in the components shown in FIG. 1.

FIG. 3 is a plan view of some of the sheet transfer components included in the apparatus according to the invention.

FIG. 3A is an elevational view of one of the three sheet transfer cars used in an apparatus according to the invention.

FIG. 4 is a side elevational view of a lift/lower system used int eh loading station and two sheet transfer cars, used in the apparatus.

FIG. 5 is a plan view of the lift/lower system shown in FIG. 4.

FIG. 6 is an elevational view of the components including in the forming station of an apparatus according to the invention.

FIG. 7 is an enlarged elevational view of one of the mold assembly sets and the forming station lift/lower system and mold plug sets shown in FIG. 6.

FIG. 8 is a further enlarged elevational view of the movable mold assembly in the mold assembly set shown in FIG. 7 and associated components.

FIG. 9 is an enlarged view of the stationary mold assembly of the mold assembly set shown in FIG. 7 and associated components.

FIG. 10 is a plan view of a clamping frame linear transfer system suitable to linearly transfer sheet transfer cars from the loading station to the oven and from the oven to the forming station.

FIG. 11 is a side elevational view of the transfer system shown in FIG. 10.

FIG. 12 is an enlarged fragmentary end view of portions of the transfer systems and portions of one of the transfer cars.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

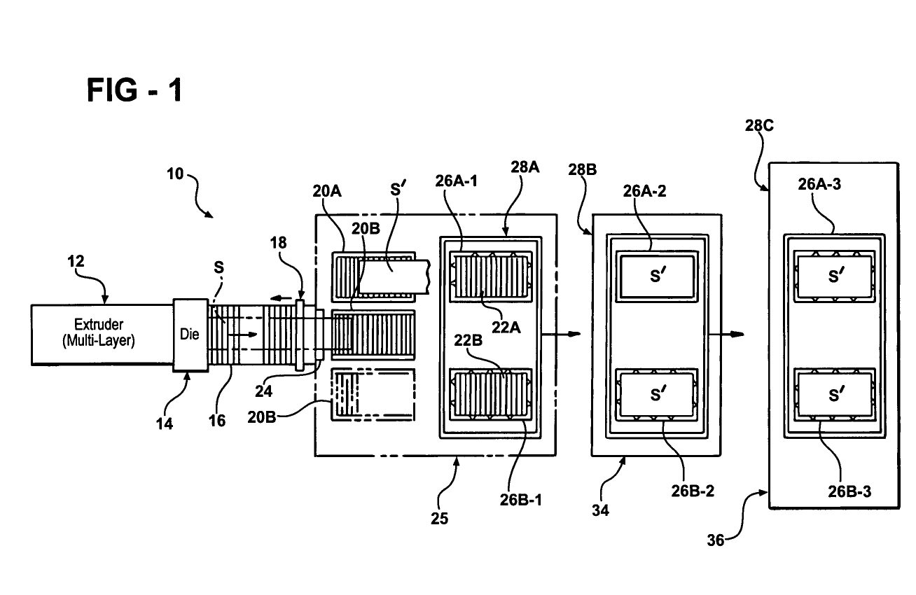

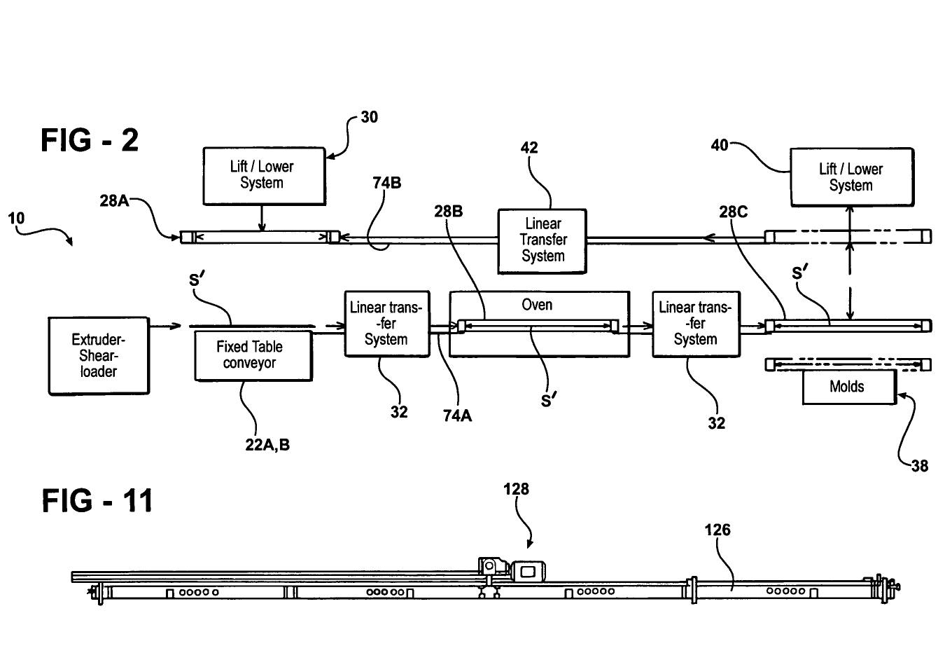

Referring to the drawings, and particularly to FIGS. 1 and 2, the apparatus 10 according to the invention includes an extruder 12 which is capable of continuously creating multiple layers of plastic sheet, which may be of various compositions, and which are layered together into a single continuous sheet S exiting an extruder die 14.

The sheet S exits onto a shear conveyor 16 which may be comprised of powered roller type conveyor with the rollers cooled as necessary with a cooling system indicated to render the extruded sheet S capable of being handled.

A commercially available “flying” shear 18 is driven back and forth over the sheet S to cut the sheet S into discrete lengths S′ while the sheet S is being extruded.

The cut sheets S′ are conveyed alternately onto two conveyor shuttles 20A, 20B which are shifted rapidly in a lateral direction to bring each conveyor shuttles 20A, 20B alternately into alignment with the shear conveyor 16 and with respective sheet supports comprising stationary conveyor tables 22A, 22B.

Each conveyor shuttle 20A, 20B alternately receives a cut sheet S′ and shifts into alignment with a respective fixed conveyor table 22A or 22B and discharges its sheet S′ thereon while the other conveyor shuttle 20A, 20B is being loaded.

A shelf 24 can be provided to prevent sagging of the sheets S′ during transitions where moving the next shuttle conveyor into position, as the sheets S′ are continuously moving.

The rate of feed of the extruder 12 of course must be set to the speed of operation of the other equipment.

Positioned above and in alignment with the fixed table conveyors 22A are a pair of sheet clamping frames 26A, 26B carried on one of three sheet transfer cars 28A.

The sheet transfer car 28A is lowered by a lift/lower system 30 to bring the frames 22A, 22B down around the sheets S′ on each conveyor table 22A, 22B.

A series of gripper clamps on the clamping frames engage the perimeter of the sheets S′.

The clamping frames 26A, 26B are then transferred linearly on the sheet transfer 28A by a linear transfer system 32 into an oven 34.

At the same time, a second sheet transfer car 28B is transferred into a forming station 36 with previously heated sheets S′ clamped therein.

The sheets S′ after transfer into the forming station 36 are lowered onto a set of molds 38 by a lift/lower system 40 after which a thermomolding process molds the sheets S′ in upper and lower part halves. The thermoforming is carried out by conventional methods involving a vacuum applied to the molds assisted by mold plugs described herein. Such techniques are well known in the art and do not themselves comprise the invention, and thus are not here described in further detail. A robot can emplace rings into the mold cavities prior to lowering the sheets S′ onto the molds.

The gripper clamps in the clamping frames 20A-3, 20B-3 are released and the transfer car 28-C is then raised by the lift/lower system 40 to a level above the oven 34, and a second linear transfer system 42 returns the empty sheet transfer car 28C to a position over the fixed conveyor tables 28A, 28B in the load station 25.

Inserts can also be emplaced into the molded cavities in the sheets S by a robot after the sheet transfer car has been raised out of the way.

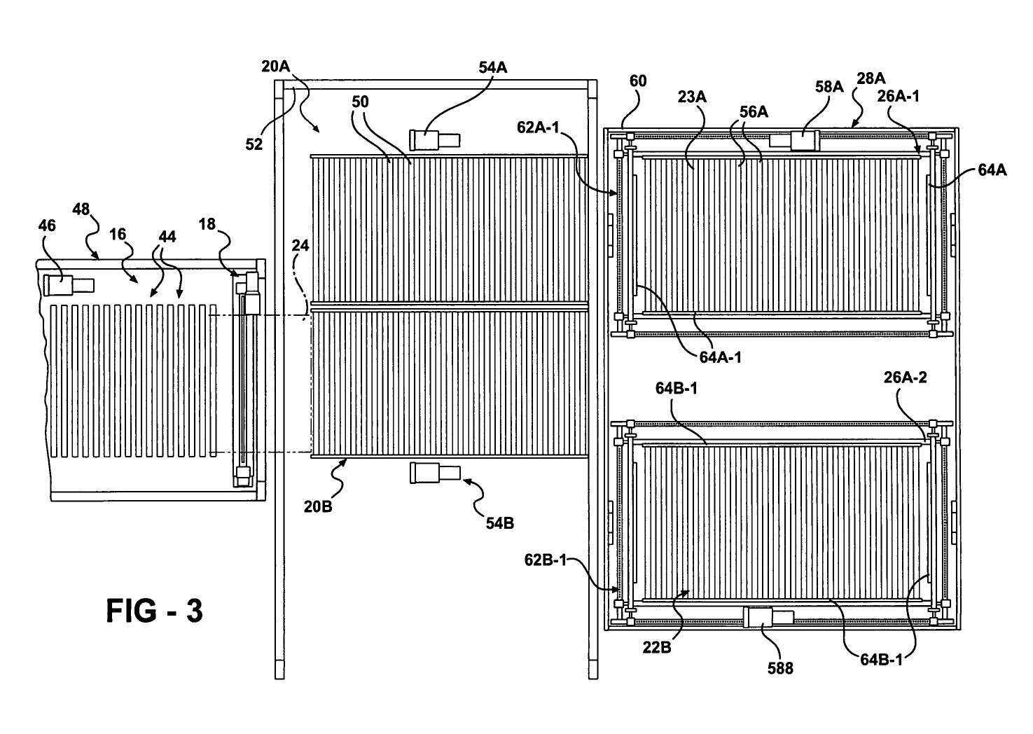

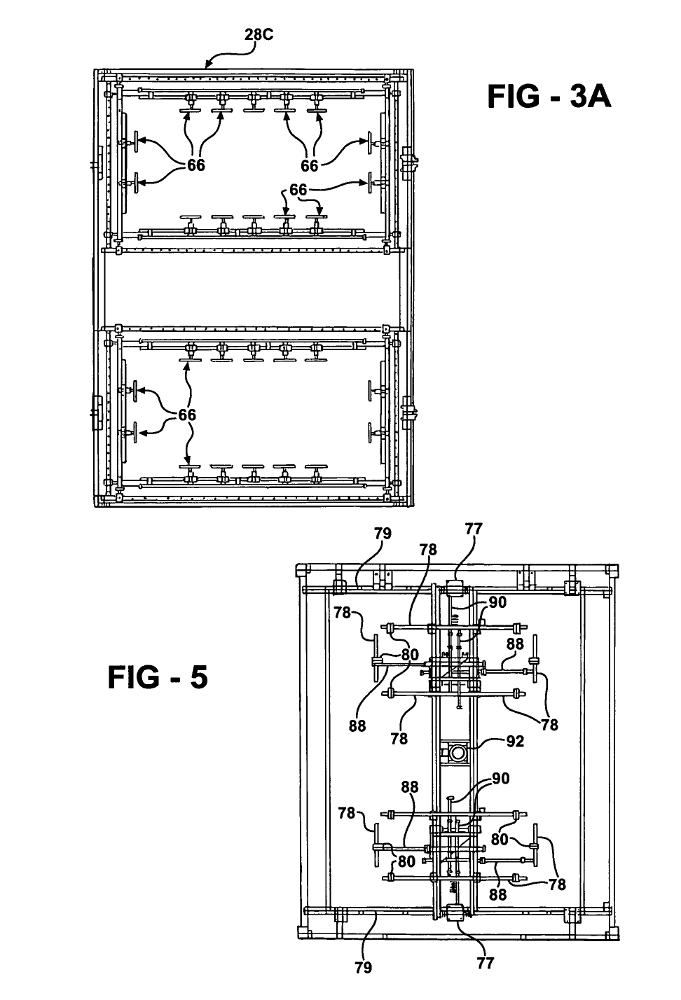

FIG. 3 shows additional details including a series of rollers 44 mounted on a frame 48, the rollers rotated by the motor 46.

The conveyor shuttles 20A, 20B also have powered rollers 50 supported in frames 52A, 52B on a framework 52 driven by motors 54A, 54B.

The fixed conveyor tables 22A, 22B similarly each have a series of rollers 56A, 56B powered by motors 58A, 58B.

As seen in FIG. 3A, the sheet transfer car 28A comprises an outer frame 60 having a pair of rectangular sheet support frames 62A, 62B supporting members making up gripper clamping frames 26A-1, 26A-2 so as to allow for an adjustment in the size thereof by removal of pins received in perforated members of the sheet support frames 62A, 62B to allow repositioning the members of the clamping frames 26A-1, 26A-2 in an adjusted position of those members. Such adjustable gripper clamping frames are very well known in the art and one thus not here described in further detail. See for an example, U.S. Pat. No. 4,938,678.

Arrays of fluid pressure operated clamps or grippers 64A, 64B are arranged around the interior of the clamping frames 26A-1, 26A-2. The gripper cylinders 66 (FIG. 3A) in the array 64A, 64B are described in copending application U.S. Ser. No. 10/654,278, filed Sep. 2, 2003, incorporated by reference herein, those cylinders being of a commercially available type in which the clamping jaws are opened by fluid pressure and closed by a spring force acting through on over center linkage when the fluid pressure is relieved. The linkage insures that the grippers remain closed even if air pressure is lost. Suitable manifolding and pressure connections are carried on the sheet transfer cars 28A, 28B, 28C for opening the gripper cylinders, by a known power actuator operated connection, such as described in U.S. Pat. No. 6,454,557 B1, incorporated herein by reference.

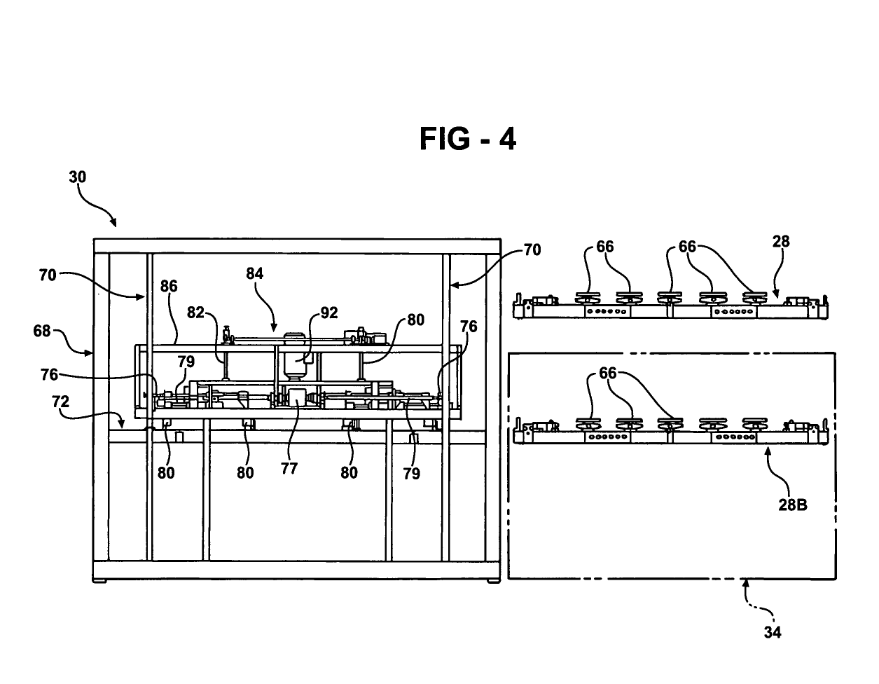

FIGS. 4 and 5 show further details of a lift/lower system 30 and lift/lower system 40. Lift/lower system 30 comprises a framework 60 having four gear rack posts 70 supporting a platform 72 onto which is rolled each sheet transfer car 28A, 28B, 28C from an adjacent track 74 (FIG. 2) extending over the oven 34.

A supporting connection between the gear rack posts 70 and platform 72 comprises a series of pinion gears 76 which allow raising and lowering of the platform 72 to raise or lower the sheet transfer car 28A, B, C. Such a vertical drive is shown in U.S. Pat. No. 5,814,185 and copending application Ser. No. 10/218,982 and also hereinafter in connection with the lift/lower system 40.

Also preferably included in the lift/lower system 30 is a sheet squaring mechanism 84 having movable members 78 forming a rectangular array having angle tabs 80 attached engageable with the edges a sheet S′ on the fixed table conveyor 22A, 22B to square the same in a similar manner to the mechanism described in detail in copending application U.S. Ser. No. 10/654,278, filed Sep. 2, 2003 incorporated by reference herein. An array of gear racks 82 are driven to lower and raise the sheet squaring mechanism 84 and a supporting sub-framework 86. In and out synchronized movement of the members is produced by motor driven gear rack shafts 88, 90.

Alternatively, fixed guides on the sheet transfer cars 28A, B, C could be used to square the sheets S′.

The platform 72 is lowered in the load station to allow the held open elongated bar jaws of the grippers 66 to be aligned with the edges of the sheet S′, and the air pressure is relieved to cause the jaws to close to grip the sheet S′ securely in its squared up orientation. An actuator (not shown) makes an air connection at this station to the clamping frame 28A, B, C to allow opening of the gripper jaws. When the air pressure is disconnected the jaws close under the influence of springs, with an over center linkage insuring that the sheet S′ remains clamped even if air pressure is lost, driven by a motor drive gear units 77 driven by motor 92 connected by cross shafts 79 to be in synchronism with each other.

After the sheet S′ are clamped into the clamping frames 26A-1, 26A-2, the platform 72 is raised slightly to clear the fixed conveyor tables 22A, B and be aligned with the track 74A and to be ready for linear transfer into the oven 34.

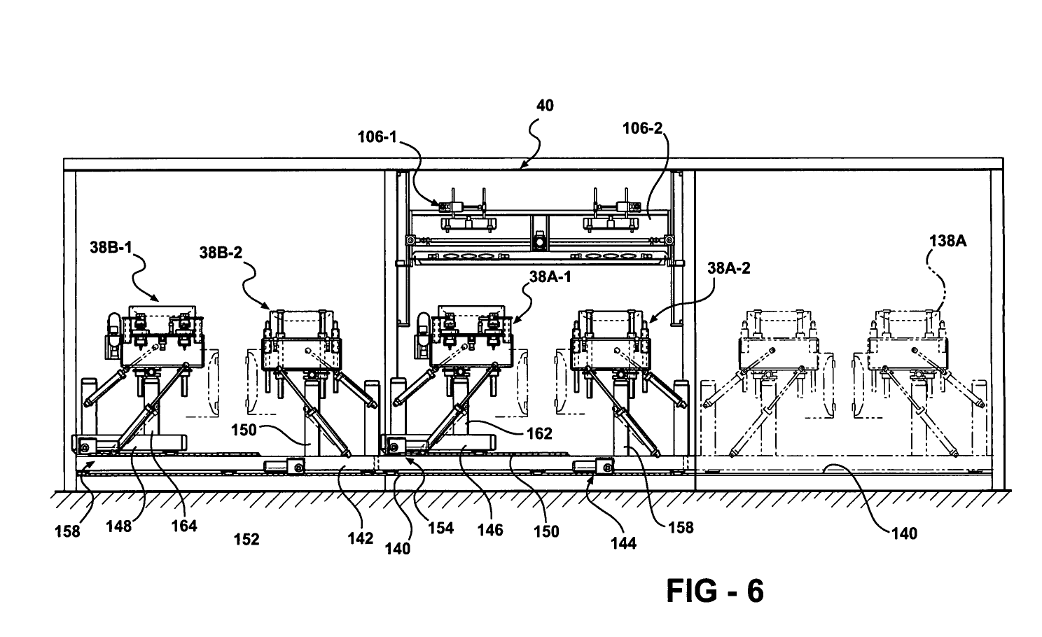

FIG. 6 depicts the major components of the forming station 36. Two sets of side-by-side mold assemblies 38A-1, 38A-2 and 38B-1 and 38B-2 are used alternately, each set alternately driven into position beneath the mold plug-platen set 106-1, 106-2, while the other mold assembly set is in a cooling/part removal position off to one side by an actuator arrangement.

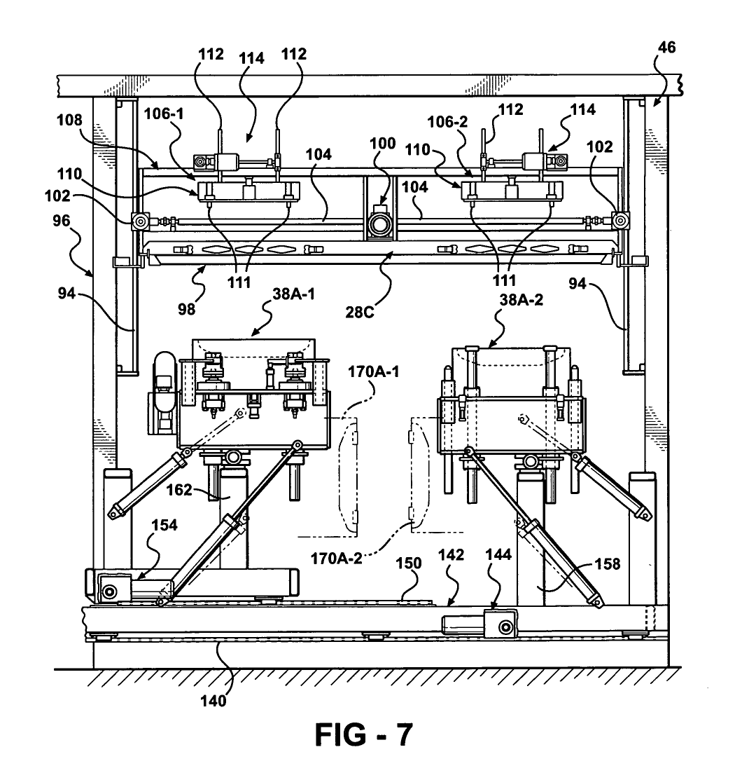

The mold assembly sets 38 are all supported on a platform 142, resting on linear bearings 140 and driven by a motor-pinion gear drive 144 (FIG. 7) comprising a part of the actuator arrangement to shift the mold assembly sets 38 to the right or left to bring one of the sets 38 beneath the lift/lower system 40.

Each mold assembly set 38A-1, 38A-2, 38B-1, 38B-2 includes a stationary mold 38A-2, 38B-2 affixed relative to the platform 142 and a mold 38A-1, 38B-1 movable relative to the platform 142. The movable mold assembly sets 38A-1, 38B-1 are supported on a respective pedestal 162, 164 affixed to a respective movable platform 146, 148, supported on linear bearings 150, 152 and driven by an actuator arrangement which may be comprised of a respective motor pinion gear drive 154, 156 towards and away from one of the adjacent stationary mold assembly sets 38A-2 or 38B-2 which are mounted on pedestals 158, 160 affixed to main platform 142.

The lift/lower mechanism 40 shown in FIG. 7 is similar to mechanism 30 in that a set of four gear rack posts 94 is supported in a framework 96, with a horizontal framework platform 98 supported and driven up and down thereon by a drive motor gear unit 100 and pinion 102 connected by cross shafts 104.

A clamp frame 28A, B, C is rolled on and off the support platform 98 from aligned tracks.

Also carried on the framework platform 98 is a mold plug platen assembly 106 mounted on a sub-framework 108 affixed to the framework 98. A mold plug platen assembly 106 includes a pair of mold plug platens 110 carrying plugs 111, each platen 110 supported for up and down movement on an array of gear rack posts 112 driven by a motor, gear unit, cross shaft system 114 to allow the platens 110 to be lowered.

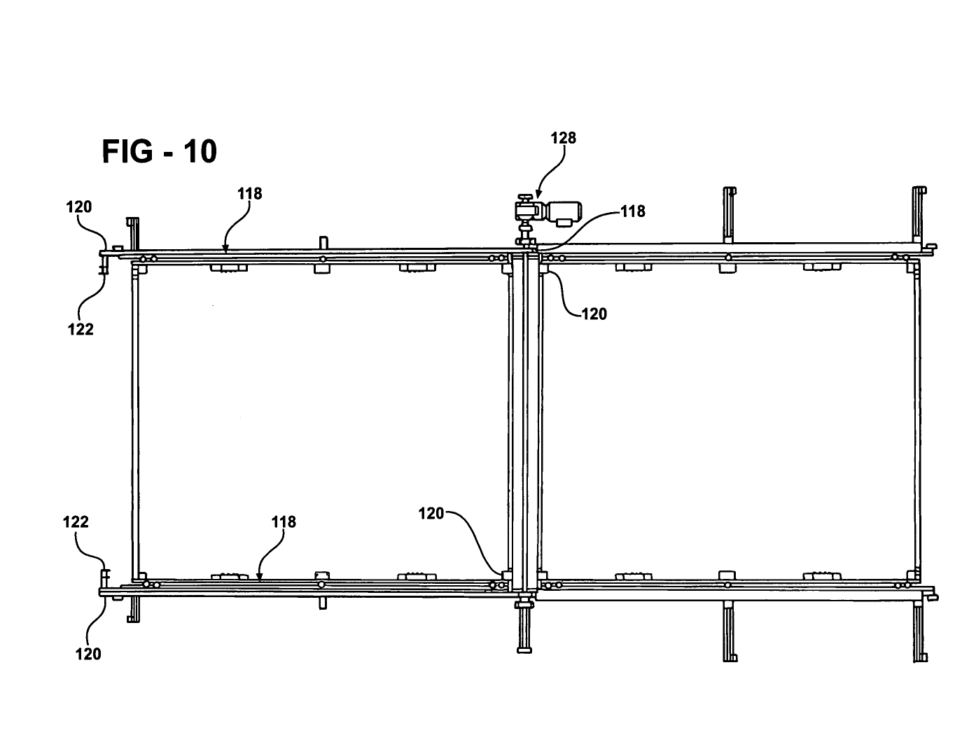

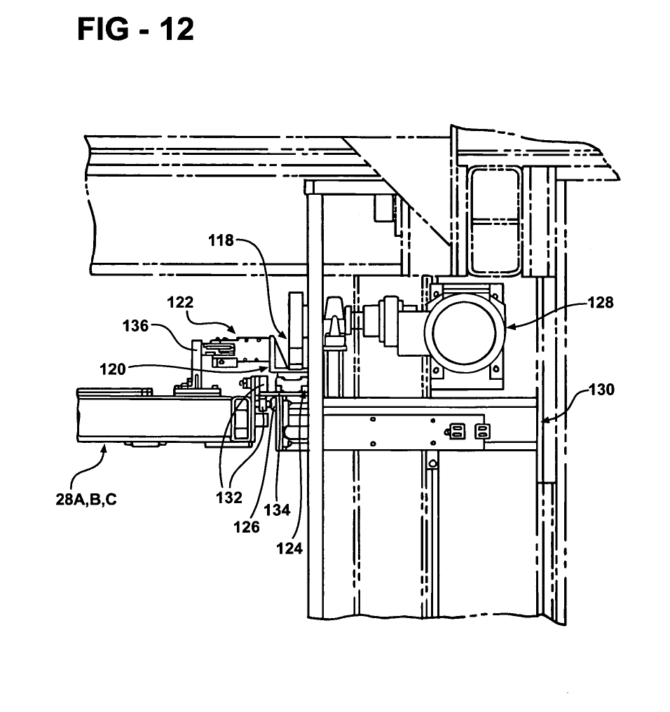

FIGS. 10-12 show a suitable linear transfer system, comprised of slidable horizontal gear racks 118 attached to shuttle bars 120 supporting gripper mechanism 122.

The gear racks 118 and shuttle bars 120 are supported on bearings 124. A pinion gear 126 is engaged with the gear racks 118 driven by a motor drive unit 128 supported on a frame 130 to be reciprocated when the motor drive unit 128 is activated by the machine controls.

The grippers 122 are engageable with fingers 136 on the sheet transfer cars 28A, B, C to cause the cars to be linearly advanced by the motion of the gear racks 118 and shuttle bars 122.

The sheet transfer cars 28A, B, C have roller sets 132 mounted on its sides to be engaged with fixed tracks 134 to support the weight thereof. The rollers and tracks may be shaped in the well known manner to guide linear movement of the sheet transfer cars 28A, B, C.

Such a linear transfer system has been used in prior designs for linear transfer of sheet transfer cars and may be used for both systems 32, 40.

Alternative arrangements are described in U.S. Pat. No. 5,980,231 and U.S. Pat. No. 3,669,594 incorporated by reference herein, which also shows suitable mating track and roller shapes to guide the motion along a straight path.

Mold assembly sets 38A-1 and 38B-1 are identical to each other as are mold assembly sets 38A-2 and 38-B-2.

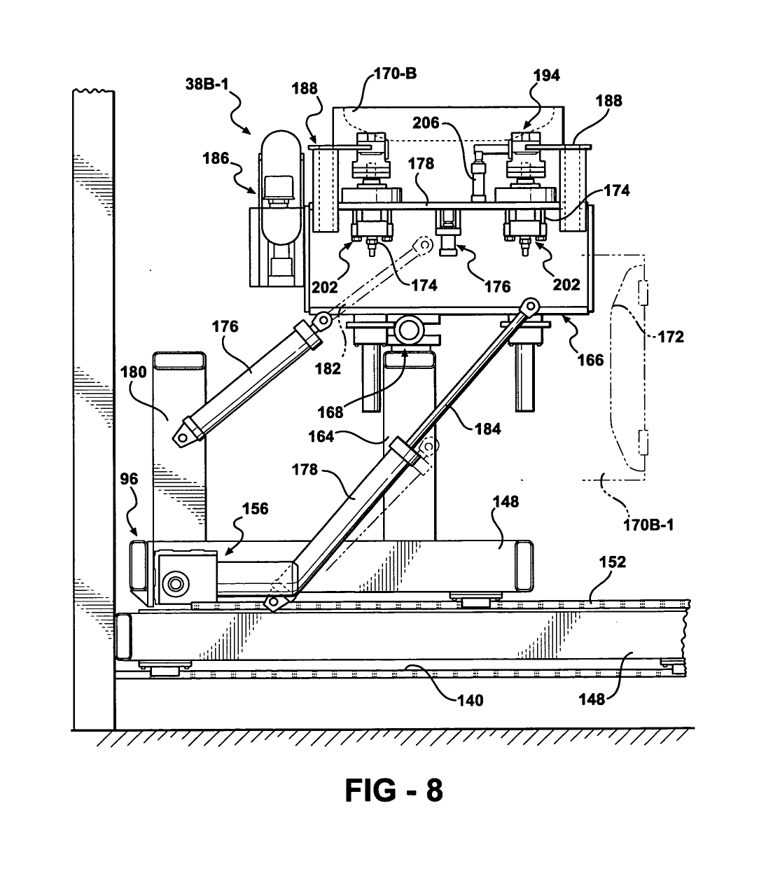

Referring to FIG. 8, movable mold assembly 38B-1 includes a platen 166 mounted on a pivot connection 168 attached to the pedestal structure 164 to be rotatable between a horizontal position with a mold cavity 172-1 facing up to a vertical position where cavity 172-1′ is facing a mold cavity 172-2 in the mold 170B-2 of the relatively fixed mold assembly 38B-1.

The platen 166 in turn mounts the mold 170B-1 having the mold cavity 172-1. Suitable tool locks 174 and a cylinder operated locating pin 176 insure secure, precise location of the mold 170B- 1 on the upper surface of a top plate 178 of platen 166.

Prior to lowering of the sheets S′ onto the cavities 172, a robot can emplace rings in the cavity 170 for creating an access opening in the completed fuel tank.

The platen 166 is caused to pivot 90° on the pivot connection 168 by a an actuator arrangement which may includes pair of double acting power cylinders 176, 178, a power cylinder 176 pivoted at a lower end to an anchoring structure 180 fixed to platform 148 and a power cylinder 178 anchored at its lower end to platform 148.

The actuator rod 182, 184 of the power cylinders 176, 178 are pinned to the platen 166, such that when the power cylinders 176, 178 are stroked so as to retract the rods 182, 184, the platen 166 and mold 170 are tilted down 90° so that the mold cavity 172-1 faces the stationary mold assembly 38B-2 and mold cavity 172-2.

The power cylinders and other components to be described may be hydraulically operated, and a suitable hydraulic accumulator 186 may be mounted to the platen 166.

The drive unit motor 156 advances the mold assembly 38B-1 towards the stationary mold assembly 38B-2 to bring the two mold assemblies 38B-1, 38B-2 together, bringing flanges on the formed sheets in the molds 170B-1, 170B-2 into abutment.

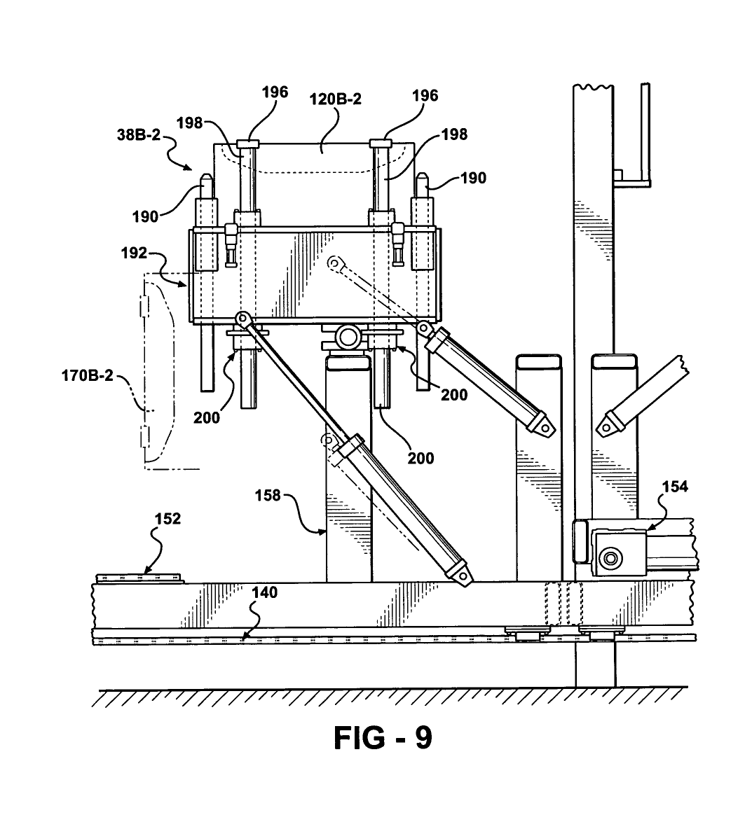

Receivers 188 for mating with guide pins 190 on the platen 192 for the other mold assembly 38B-2 (FIG. 9) are mounted to the platen 166 to insure that the molds 170B-1, 170B-2 are in precise alignment.

The mold assemblies 38B-1, 38B-2 incorporate the platen locking and clamping system described and claimed in U.S. Pat. No. 5,814,185 and in U.S. Ser. No. 10/218,982, referenced above.

In this arrangement, bayonet couplings are established when bayonet receivers 194 receive bayonet fittings 192 (FIG. 9) on the ends of rods 198 fixedly mounted to the platen 192.

Rotation of the receivers 194 creates a positive locking together of the mold assemblies, a pneumatic rotary actuator 200 acting on the lower end of each rod 198 to carry out the locking and unlocking rotation.

Large diameter hydraulic cylinders 202 are coupled to the mold assembly 38B-1 and receivers 194 to generate large squeezing forces drawing the molds 170B- 1 together to fuse the abutting flanges together.

A position sensor 206 tracks the travel of the molds 170B- 1, 170B-2 as the cylinders 202 are operated, and the system controller (not shown) actuates the drive motor 156 to advance the mold assembly 38B-1 on the linear bearing 152 as the drawing action of the cylinders 202 proceeds. This action prevents the motor 156 from being overloaded by attempting to itself carry out the squeezing action.

The set of mold assemblies 38B-1, 38B-2 is shifted to a cooling/unload area shown on the left in FIG. 6 until sufficiently cooled, with the other set of mold assemblies 38A-1, 38A-2 is simultaneously shifted below the mold plugs 106-1, 106-2 to begin the next cycle by activation of the motor 144 and linear movement of the platform 142.

When sufficiently cooled, the molds 170-1, 170-2 are separated by retraction of the movable mold assembly 38B-1 by operation of motor drive 156, the completed part staying in mold 170B-1.

The mold assemblies 38B-1, 38B-2 are again pivoted up, and a robot or other device may be employed to remove the part at that time. The mold assemblies 38B-1, 38B-2 are then in oriented for another forming cycle when again shifted into position beneath the lift/lower system 40.

1. A method of making a hollow plastic part by a thermoforming process including:
continuously extruding a multiple layer sheet onto a shear support and cutting said extruded sheet into discrete lengths while said sheet is being extruded;
immediately loading in pairs of successively cut sheets one at a time side by side onto a sheet transfer car and transferring said car with said loaded pair of sheets into an oven and heating said sheets therein to a proper temperature for thermoforming;
transferring said transfer car and heated sheets into a forming station and thermoforming respective pieces of said part from each sheet in cavities in molds in said forming station;
thereafter forcing said molds with said formed sheets together to fuse said pieces together into a completed part; and
thereafter separating said molds and removing said completed part.

2. The method according to claim 1 wherein sheets are loaded into said transfer car by a pair of shuttles each alternately receiving a successive cut sheet, each shuttle shifted to be aligned with a respective one of a pair of sheet supports and conveying said sheets onto a respective support, and positioning a respective one of two clamping frames on said transfer car around a respective cut sheet on a support and clamping the same into said respective clamping frame.

3. The method according to claim 2 wherein said transfer car is positioned above said pair of supports as a cut sheet is deposited on each support, and said transfer car is thereafter lowered to enclose said sheets in respective clamping frames.

4. The method according to claim 3 wherein said transfer car is elevated to clear said supports after said sheets are clamped in to a respective clamping frame and thereafter moved into said oven.

5. The method according to claim 2 wherein successive transfer cars are loaded with pairs of sheets by said shuttles, said successive transfer cars thereafter occupying said oven and said forming station respectively.

6. The method according to claim 1 wherein said cut sheets are deposited onto said support at least in part by conveying said cut sheets onto said supports.

7. The method according to claim 2 wherein said cut sheets are moved onto each of said shuttles by a conveyor on each of said shuttles.

8. The method according to claim 1 wherein each of said molds is mounted on a platen, said molds are initially each positioned with a cavity facing upward and said heated sheets are lowered by said transfer car onto a respective mold cavity and thereafter thermoformed into said cavity.

9. The method according to claim 8 wherein said molds are pivoted to move said mold cavities into facing positions and are thereafter brought together to fuse said pieces together.

10. The method according to claim 9 wherein said molds are locked together and thereafter squeezed together by hydraulic cylinders to fuse said molded sheets together.

11. The method according to claim 9 wherein two sets of molds are alternately positioned to receive a pair of sheets to be thermoformed while the other set remains forced together to cool said part prior to separating said molds.

12. The method according to claim 1 wherein said shear support is cooled to cool said extruded sheet.

13. The method according to claim 12 wherein said sheet is conveyed onto said shear support.

14. The method according to claim 8 wherein a pair of mold plugs are lowered as said sheets are lowered onto said mold cavities and are thereafter extended to be engaged with said sheets to assist said thermoforming thereof.

15. The method according to claim 14 wherein said transfer car is lowered on a support to bring said sheets over said mold cavities and said mold plugs are mounted to said support to be lowered therewith.

16. The method according to claim 8 wherein said sheet transfer car is lowered to bring said heated sheets over said mold cavities.

17. The method according to claim 16 wherein said transfer car releases said heated sheets after thermoforming thereof and is raised thereafter.

18. The method according to claim 17 wherein an insert is placed in at least one of said cavities formed in said sheets after said transfer car is raised.

19. The method according to claim 17 wherein said transfer car is raised above the top of said oven when being raised from said mold cavities and are thereafter transferred linearly back to a position over said supports preparatory to being loaded with another two cut sheets by said shuttles.

20. A twin sheet thermoforming apparatus comprising:
an extruder for continuously extruding a continuous plastic sheet;
a moving shear cutting said extruded sheet into cut sheets while said sheet is being extruded;
a pair of shuttles each receiving alternately sheets sheared from said extruded sheet;
a series of transfer cars, each having a pair of clamping frames adapted to clamp a cut sheet therein;
a transfer system successively positioning each of said transfer cars over a pair of stationary cut sheet supports;
said shuttles each shifting from a position aligned with said shear to a position aligned with one of said sheet supports;
a conveyor for moving each cut sheet from an aligned shuttle onto a respective sheet support;
a lift/lower system lowering each transfer car to position a cut sheet on said sheet support within clamping frame thereon, said clamping frames including gripper clamps adapted to clamp to the edges of said cut sheet therein;
an oven for heating said cut sheets to a proper final temperature for thermoforming;
a transfer system for transferring each sheet transfer car into said oven after clamping a pair of sheets into said clamping frames;
said transfer system at the same time transferring another transfer car from said oven into a forming station;
said forming station including a set of side by side mold assemblies each including a mold having a mold cavity;
said mold assemblies each including positioning arrangement positioning said mold cavity facing towards said sheet transfer car loaded with said cut sheets;
a lift/lower system lowering said transfer car to position said cut sheets over a respective mold cavity;
said lift/lower system raising said transfer car after said sheets are released from said clamping frames;
said positioning arrangement reorienting said molds after said thermoforming apparatus has molded said sheets to a respective mold cavity so that said mold cavities and sheets therein are facing each other and moving said mold cavities and molded sheets thereon together to fuse said molded sheets together to form a hollow part;
said positioner arrangement thereafter separating said molds to allow removal of said hollow part.

21. An apparatus according to claim 20 further including a second set of mold assemblies, each set alternately positioned beneath a transfer car loaded with cut sheets to alternately mold therein pairs of cut sheets.

22. An apparatus according to claim 20 further including a return linear transfer system transferring each transfer car back over said oven to said position above said stationary cut sheet support.

23. An apparatus according to claim 20 wherein each of said shear support, said shuttles and said cut sheet supports are comprised of powered roller conveyors.

24. An apparatus according to claim 20 further including a pair of mold plug assemblies carried down and up with said transfer car, said mold plug assemblies each including actuators for moving respective mold plugs into a respective sheet overlying a respective mold cavity.

25. A twin sheet thermoformer apparatus having a forming station including a first set of rotatable mold assemblies each assembly including a mold having an exposed mold cavity; said mold of each assembly pivotally mounted above a platform to be rotatable between a position with said mold cavities facing up and a rotated position with said cavities facing each other, said mold assemblies each having actuators adapted to rotate said molds between said positions;
said mold assemblies further mounted to be relatively movable linearly together and apart and an actuator arrangement for moving said molds together and apart to bring a molded sheet in each cavity into abutment to be fused together and then separated to allow removal of a completed part produced by said fusing together of said molded sheets.

26. The apparatus according to claim 25 further including a second set of two mold assemblies each assembly including a mold having an exposed mold cavity; said mold of each assembly pivotally mounted above said platform to be rotatable from a position where said cavity is facing up to a position where said cavity of each mold is facing the cavity of the other mold;
said mold assemblies including actuators to rotate said molds between said positions, said mold assemblies being linearly movable on said platform together and apart from each other to bring said mold cavities together and apart and an actuator arrangement bringing a molded sheet in each cavity into abutment to be fused together and separating said molds to allow removal of a part produced by said fusing; and
a linear actuator shifting said platform sideways to allow said first and second set of mold assemblies to be alternately positioned beneath a lift/lower system positioning sheets to be molded on the mold cavities of the molds on one of said mold assemblies at a time.
